(19) United States
(12) Patent Application Publication
(10) Pub. No.: US 2018/0024316 A1
(43) Pub. Date: Jan. 25, 2018

(54) Wide-Angle Imaging Lens Module

(71) Applicant: Tan Cian Technology Co., Ltd., Taichung City (TW)

(72) Inventor: Shih-Yuan Chang, Jhubei City (TW)

(21) Appl. No.: 15/347,954

(22) Filed: Nov. 10, 2016

(30) Foreign Application Priority Data
Jul. 21, 2016 (TW) 105122988

(51) Int. Cl. G02B 13/00; G02B 27/00; G02B 9/58; G02B 5/00; G02B 5/20

(52) U.S. Cl. CPC G02B 13/004; G02B 5/005; G02B 5/208; G02B 9/58; G02B 27/0025

(57) ABSTRACT

An wide-angle imaging lens module satisfies: 0.84<|f1|/f<2.28; 0.52<f2/f<1.26; 0.49<f3/f<1.12; 0.32<|f4|/f<0.70; FOV>100′; and TTL/ImagH<2.80, where f1 denotes a focal length of a first lens, f2 denotes a focal length of a second lens, f3 denotes a focal length of a third lens, f4 denotes a focal length of a fourth lens, f denotes a total system focal length of the wide-angle imaging lens module, FOV denotes a total system field-of-view angle of the wide-angle imaging lens module, TTL denotes a system length of the wide-angle imaging lens module, and ImagH denotes a maximum image height of the wide-angle imaging lens module.

### CROSS-REFERENCE TO RELATED APPLICATION

This application claims priority to Taiwanese Patent Application No. 105122988, filed on Jul. 21, 2016.

### FIELD

The disclosure relates to a lens module, and more particularly to a wide-angle imaging lens module.

### BACKGROUND

With rapid change in portable electronic devices, the portable electronic devices with an imaging lens module can not only take video and photographs, but also function as an environmental monitor device or a vehicle video recording device. To satisfy imaging quality from consumer demand, the imaging lens module in design is required to provide good imaging quality in a light deficient environment or dynamic range of shades of light and dark while being miniaturized.

However, in optical lens design, it is insufficient to enable the imaging lens module to be miniaturized while maintaining imaging quality by reducing proportionally a size of the imaging lens module. In the design process, material properties and assembly yield of the imaging lens module should also be considered.

Therefore, techniques for miniaturizing an imaging lens module are obviously difficult than those of a traditional imaging lens. It is a goal that the imaging lens module is miniaturized while having a wide angular view field and enhancement of the imaging quality.

### SUMMARY

An object of the present disclosure is to provide a wide-angle imaging lens module that provides a wide angular view of field and corrections of optical system aberrations.

According to the present disclosure, a wide-angle imaging lens module includes a negative refractive power, an aperture stop, a second lens having a positive refractive power, a third lens having a positive refractive power, and a fourth lens having a negative refractive power. The first lens, the aperture stop, the second lens, the third lens and the fourth lens are arranged in sequence from an object side to an image side along an optical axis of the wide-angle imaging lens module. Each of the first, second, third and fourth lenses has an object-side surface facing toward the object side, and an image-side surface facing toward the image side to allow an imaging light to pass therethrough. The image-side surface of the first lens is concave away from the image side. The image-side surface of the second lens is convex toward the image side. The image-side surface (32) of the third lens is convex toward the image side. At least one of the object-side and image-side surfaces of the third lens is an aspherical surface. The image-side surface of the fourth lens is convex toward the image side. Each of the object-side and image-side surfaces of the fourth lens is an aspherical surface.

The wide-angle imaging lens module satisfies:
0.84<|f1|/f<2.28;
0.52<f2/f<1.26;
0.49<f3/f<1.12;
0.32<|f4|/f<0.70;
FOV>100′; and
TTL/ImagH<2.80,
   where f1 denotes a focal length of the first lens, f2 denotes a focal length of the second lens, f3 denotes a focal length of the third lens, f4 denotes a focal length of the fourth lens, f denotes a total system focal length of the wide-angle imaging lens module, FOV denotes a total system field-of-view angle of the wide-angle imaging lens module, TTL denotes a system length of the wide-angle imaging lens module, and ImagH denotes a maximum image height of the wide-angle imaging lens module.

### BRIEF DESCRIPTION OF THE DRAWINGS

Other features and advantages of the disclosure will become apparent in the following detailed description of the embodiments with reference to the accompanying drawings, of which:

FIG. 1 is a schematic diagram that illustrates a wide-angle imaging lens module of a first embodiment according to the disclosure;

FIGS. 2(A) to 2(D) show different graphs relating to optical characteristics of the wide-angle imaging lens module of the first embodiment;

FIG. 3 shows a table including optical data of lenses used in the wide-angle imaging lens module of the first embodiment;

FIG. 4 shows a table including conic constants and aspherical coefficients of the lenses used in the wide-angle imaging lens module of the first embodiment;

FIG. 5 is a schematic diagram that illustrates a wide-angle imaging lens module of a second embodiment according to the disclosure;

FIG. 6(A) to 6(D) show different graphs relating to optical characteristics of the wide-angle imaging lens module of the second embodiment;

FIG. 7 shows a table including optical data of lenses used in the wide-angle imaging lens module of the second embodiment;

FIG. 8 shows a table including conic constants and aspherical coefficients of the lenses used in the wide-angle imaging lens module of the second embodiment;

FIG. 9 is a schematic diagram that illustrates a wide-angle imaging lens module of a third embodiment according to the disclosure;

FIGS. 10(A) to 10(D) show different graphs relating to optical characteristics of the wide-angle imaging lens module of the third embodiment;

FIG. 11 shows a table including optical data of the lenses used in the wide-angle imaging lens module of the third embodiment;

FIG. 12 shows a table including conic constants and aspherical coefficients of the lenses used in the wide-angle imaging lens module of the third embodiment;

FIG. 13 is a schematic diagram that illustrates a wide-angle imaging lens module of a fourth embodiment according to the disclosure;

FIGS. 14(A) to 14(D) show different graphs relating to optical characteristics of the wide-angle imaging lens module of the fourth embodiment;

FIG. 15 shows a table including optical data of the lenses used in the wide-angle imaging lens module of the fourth embodiment;

FIG. 16 shows a table including conic constants and aspherical coefficients of the lenses used in the wide-angle imaging lens module of the fourth embodiment; and

FIG. 17 is a table that lists optical parameters of the wide-angle imaging lens modules of the first to fourth embodiments.

### DETAILED DESCRIPTION

Before the disclosure is described in greater detail, it should be noted that like elements are denoted by the same reference numerals throughout the disclosure.

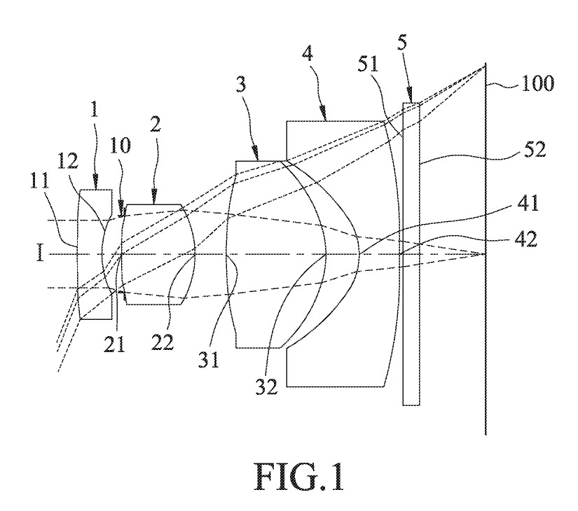

Referring to FIG. 1, a wide-angle imaging lens module according to a first embodiment of the present disclosure includes a first lens 1, an aperture stop 10, a second lens 2, a third lens 3, a fourth 4 lens and an optical filter 5, which are arranged in sequence from an object side to an image side along an optical axis (I) of the wide-angle imaging lens module. When an object at the object side emits or reflects an imaging light into the wide-angle image lens module, the first lens 1, the aperture stop 10, the second lens 2, the third lens 3, the fourth 4 lens and the optical filter 5 allow the imaging light to pass therethrough, so that the wide-angle image lens module can form an image of the object on an image plane 100 at the image side. In order to satisfy demands for weight reduction, each of the first, second, third and fourth lens 1, 2, 3 and 4 is made of a plastic material in this embodiment.

The first lens 1 has a negative refractive power, an object-side surface 11 facing toward the object side, and an image-side surface 12 facing toward the image side. The object-side surface 11 is convex toward the object side. The image-side surface 12 is concave away from the image side. The object-side and image-side surfaces 11, 12 allow the imaging light to pass therethrough. A focal length of the first lens 1 is −3.1560 mm. An Abbe number of the first lens 1 is 30.5.

The second lens 2 has a positive refractive power, an object-side surface 21 facing toward the object side, and an image-side surface 22 facing toward the image side. The object-side surface 21 is convex toward the object side. The image-side surface 22 is convex toward the image side. The object-side and image-side surfaces 21, 22 allow the imaging light to pass therethrough. A focal length of the second lens 2 is 2.0790 mm. An Abbe number of the second lens 2 is 56.

The third lens 3 has a positive refractive power, an object-side surface 31 facing toward the object side, and an image-side surface 32 facing toward the image side. The object-side surface 31 is convex toward the object side. The image-side surface 32 is convex toward the image side. The object-side and image-side surfaces 31, 32 allow the imaging light to pass therethrough. A focal length of the third lens 3 is 2.0590 mm. An Abbe number of the third lens 3 is 56.

The fourth lens 4 has a negative refractive power, an object-side surface 41 facing toward the object side, and an image-side surface 42 facing toward the image side. The object-side surface 41 is concave away from the object side. The image-side surface 42 is convex toward the image side. The object-side and image-side surfaces 41, 42 allow the imaging light to pass therethrough. A focal length of the fourth lens 4 is −1.4330 mm. An Abbe number of the fourth lens 4 is 21.

The optical filter 5 does not have a refractive power, and has an object-side surface 51 facing the object side and an image-side surface 52 facing the image side. The object-side and image-side surfaces 51, 52 allow the imaging light to pass therethrough. In this embodiment, the optical filter 5 is an infrared cut filter for prevention of the infrared light of the imaging light from being transmitted to the image plane 100 to impact the imaging quality.

Specifically, only the first, second, third and fourth lenses 1, 2, 3, 4 have the refractive power.

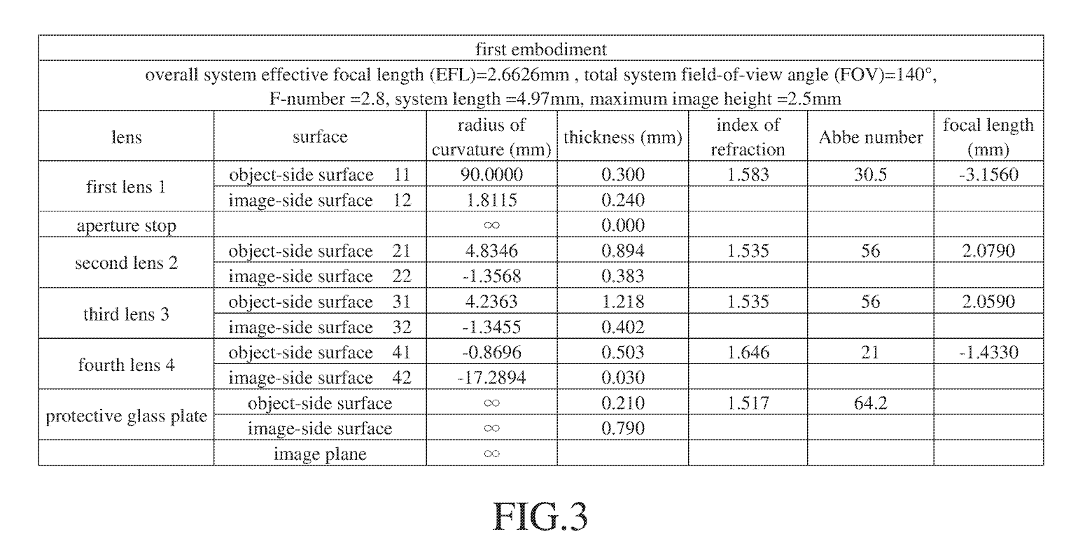

Shown in FIG. 3 is a table that lists optical data used in the wide-angle imaging lens module of the first embodiment. The wide-angle imaging lens module has an overall system effective focal length (EFL) of 2.6626 mm, a total system field-of-view angle (FOV) of 140°, and a system length of 4.97 mm. The system length refers to a distance between the object-side surface 11 and the image plane 100 along the optical axis (I). A maximum image height of the wide-angle imaging lens module is 2.5 mm. The aperture stop 10 has an F number (Fno) of 2.8.

In this embodiment, each of the object-side surfaces 11,21,31,41 and the image-side surfaces 12,22,32,42 of the first, second, third and fourth lenses 1, 2, 3 4 is an aspherical surface, and satisfies the relationship of

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {A}_{2 i} \times {Y}^{2 i} \qquad ( 1 )$$

where:

Y represents a perpendicular distance between an arbitrary point on the aspherical surface and the optical axis (I);

Z represents a depth of the aspherical surface, which is defined as a perpendicular distance between an arbitrary point on the aspherical surface that is spaced apart from the optical axis (I) by the distance Y, and a tangent plane at a vertex of the aspherical surface at the optical axis (I);

R represents a radius of curvature of an aspherical surface;

K represents a conic constant; and

A₂ᵢ represents a 2i^{th} aspherical coefficient.

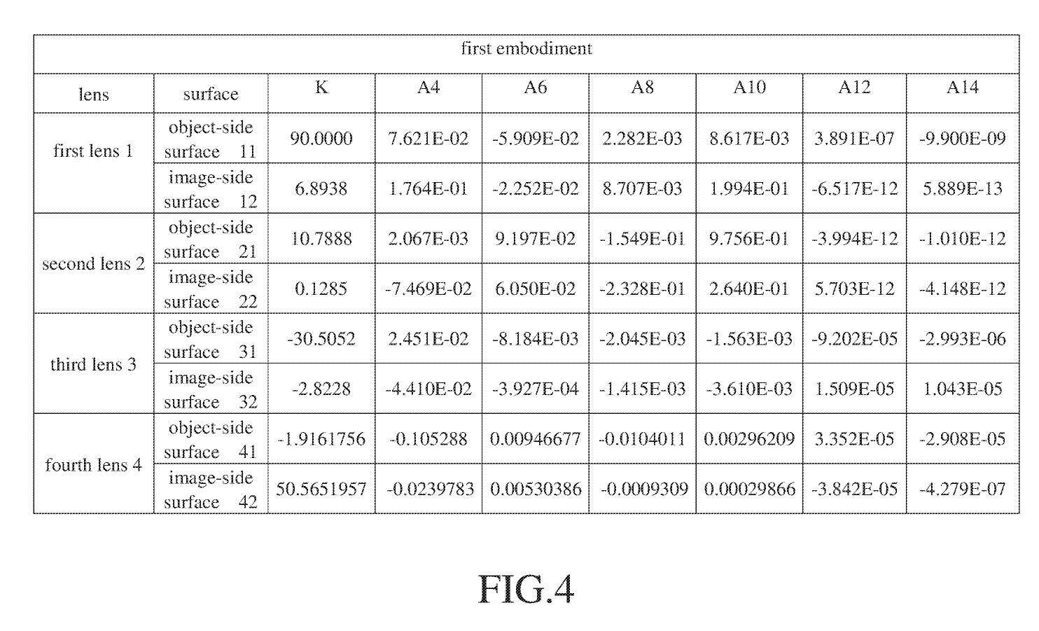

Shown in FIG. 4 is a table that lists values of K and A₂ᵢ of the first, second, third and fourth lenses 1, 2, 3, 4 in the aforementioned relationship (1) for the first embodiment.

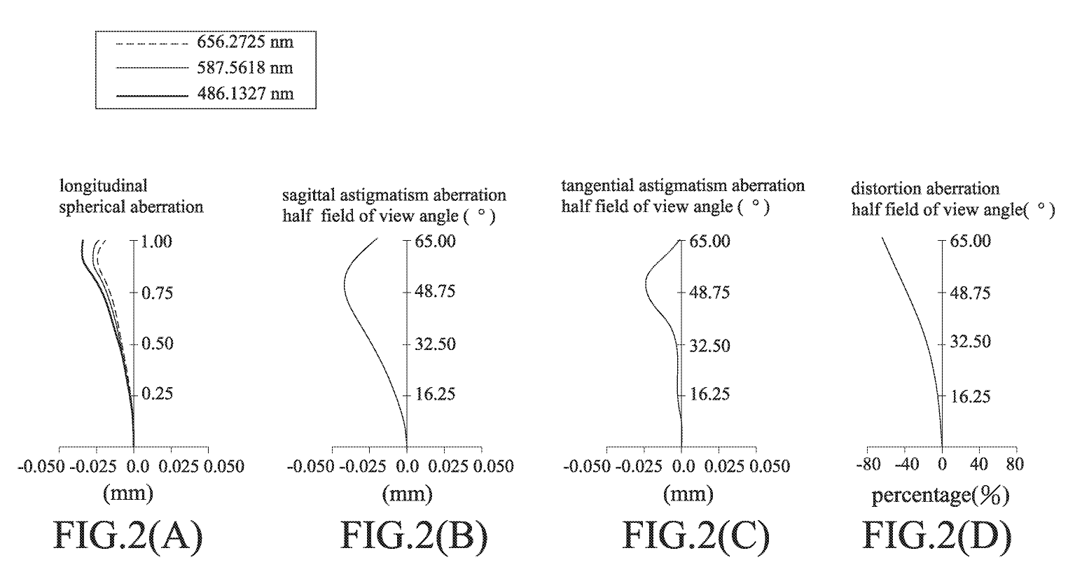

FIGS. 2(A) to 2(D) show simulation results respectively corresponding to longitudinal spherical aberration, sagittal astigmatism aberration, tangential astigmatism aberration, and distortion aberration of the first embodiment. It can be understood from FIG. 2(A) that, since deviation of each of the curves at different wavelengths falls within the range between −0.040 mm and 0 mm, the first embodiment is able to achieve a relatively low spherical aberration at different wavelengths. Furthermore, since the curves at each of wavelengths are close to each other, the first embodiment has a relatively low chromatic aberration.

It can be understood from FIGS. 2(B) and 2(C) that, since each of sagittal astigmatic field curves falls within the range between −0.040 mm and 0 mm, and each of tangential astigmatic field curves falls within the range between −0.025 mm and 0 mm, the first embodiment has relatively low sagittal and tangential astigmatism aberrations.

Moreover, as shown in FIG. 2(D), since each of distortion curves falls within the range between −60% and 0%, the first embodiment is able to meet requirements in the imaging quality of most optical systems. Under condition of enlarging the total system field-of-view angle in the first embodiment, the wide-angle imaging lens module can retain a relatively good optical performance.

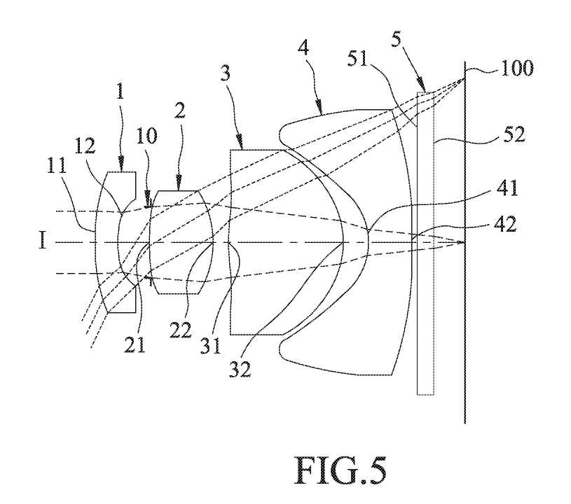

FIG. 5 illustrate a wide-angle imaging lens module according to a second embodiment of the present disclosure. The differences of the second embodiment reside in the optical data, the conic constants, the aspherical coefficients and distance parameters of the first, second, third and fourth lenses 1, 2, 3, 4 used in the second embodiment.

The focal length of the first lens 1 is −3.6110 mm. The Abbe number of the first lens 1 is 30.5. The focal length of the second lens 2 is 2.1230 mm. The Abbe number of the second lens 2 is 56. The focal length of the third lens 3 is 2.0490 mm. The Abbe number of the third lens 3 is 56. The focal length of the fourth lens 4 is −1.2640 mm. The Abbe number of the fourth lens 4 is 22.4.

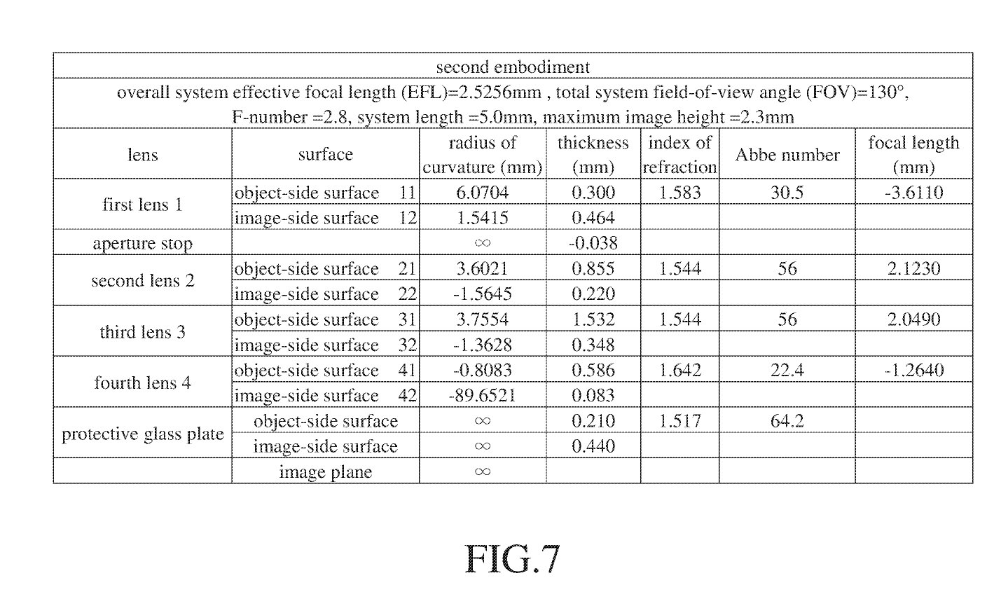

Shown in FIG. 7 is a table that lists some optical data of the first, second, third and fourth lenses used in the wide-angle imaging lens module of the second embodiment. The wide-angle imaging lens module has an overall system effective focal length of 2.5256 mm, a total system field-of-view angle of 130°, and a system length of 5.0 mm. The maximum image height of the wide-angle imaging lens module is 2.3 mm. The aperture stop 10 has an F number (Fno) of 2.8.

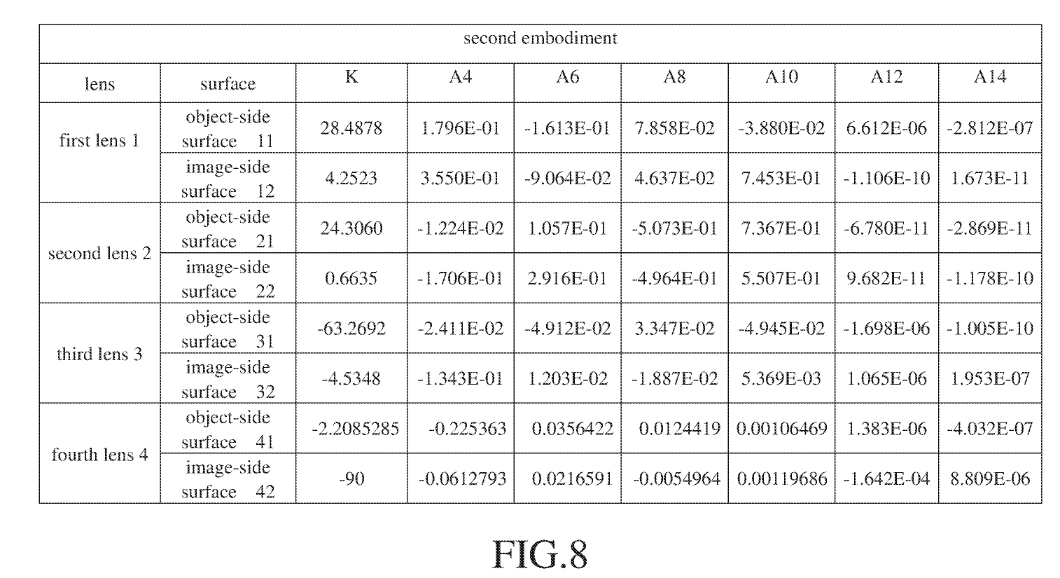

Shown in FIG. 8 is a table that lists values of K and A₂ of the first, second, third and fourth lenses 1, 2, 3, 4 in the aforementioned relationship (1) for the second embodiment.

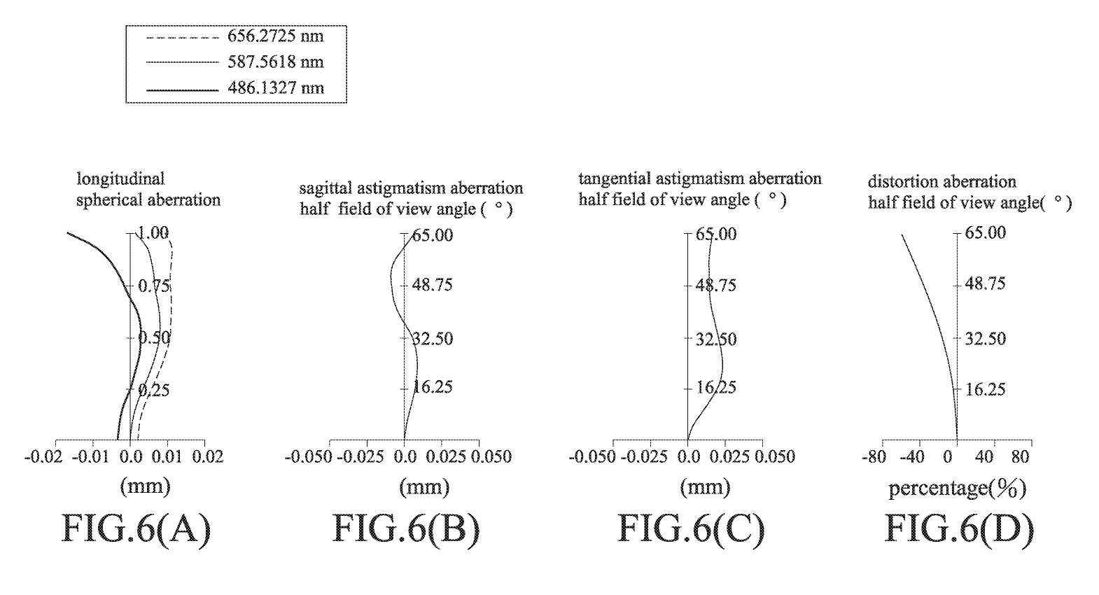

FIGS. 6(A) to 6(D) respectively show simulation results corresponding to longitudinal spherical tangential astigmatism aberration, and distortion aberration of the second embodiment. It can be understood from FIGS. 6(A) to 6(D) that the second embodiment is able to achieve a relatively good optical performance.

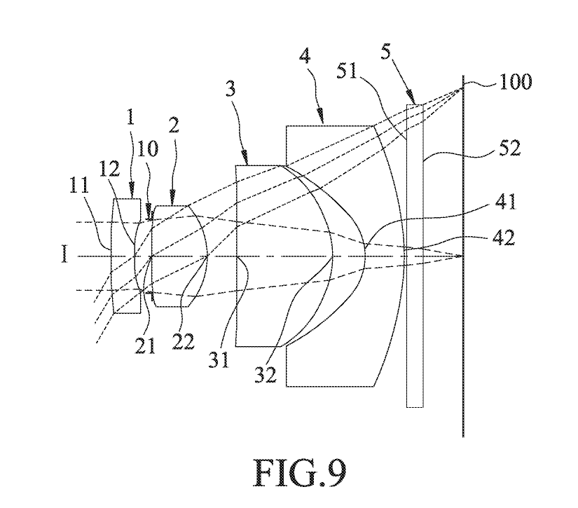

FIG. 9 illustrates a wide-angle imaging lens module according to a third embodiment of the present disclosure. The differences of the third embodiment reside in the optical data, the conic constants, the aspherical coefficients and distance parameters of the first, second, third and fourth lenses 1, 2, 3, 4 used in the third embodiment.

The focal length of the first lens 1 is −4.0530 mm. The Abbe number of the first lens 1 is 30.5. The focal length of the second lens 2 is 1.9680 mm. The Abbe number of the second lens 2 is 56. The focal length of the third lens 3 is 2.2760 mm. The Abbe number of the third lens 3 is 56. The focal length of the fourth lens 4 is −1.4220 mm. The Abbe number of the fourth lens 4 is 23.

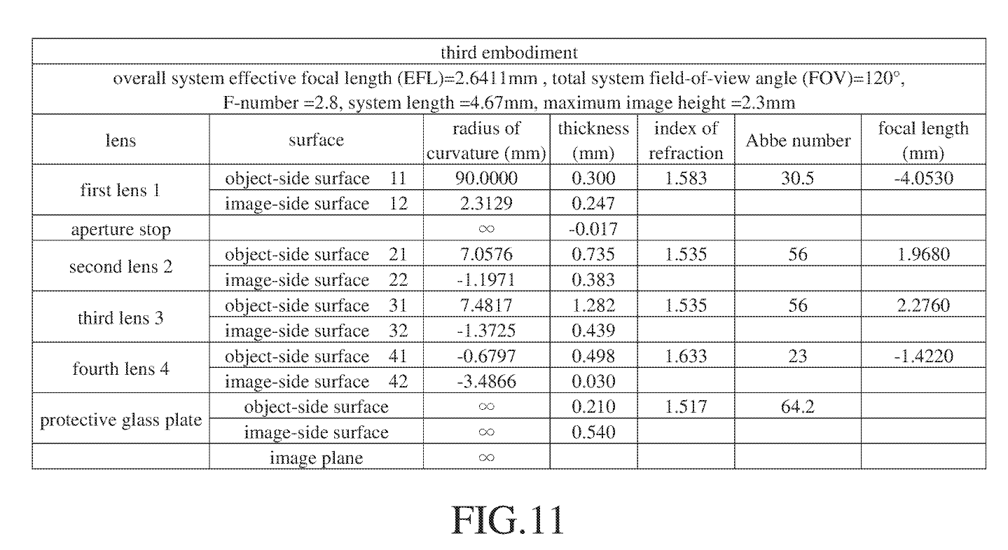

Shown in FIG. 11 is a table that lists some optical data of the first, second, third and fourth lenses 1, 2, 3, 4 used in the wide-angle imaging lens module of the third embodiment. The wide-angle imaging lens module has an overall system effective focal length of 2.6411 mm, a total system field-of-view angle of 120°, and a system length of 4.67 mm. The maximum image height of the wide-angle imaging lens module is 2.3 mm The aperture stop 10 has an F number (Fno) of 2.8.

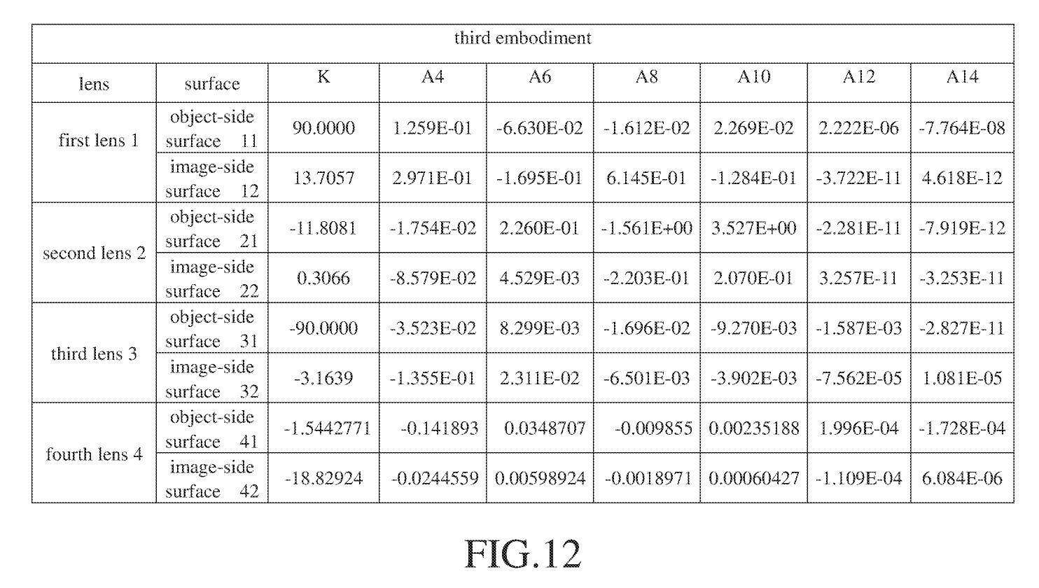

Shown in FIG. 12 is a table that lists values of K and A₂ᵢ of the first, second, third and fourth lenses 1, 2, 3, 4 in the aforementioned relationship (1) for the third embodiment.

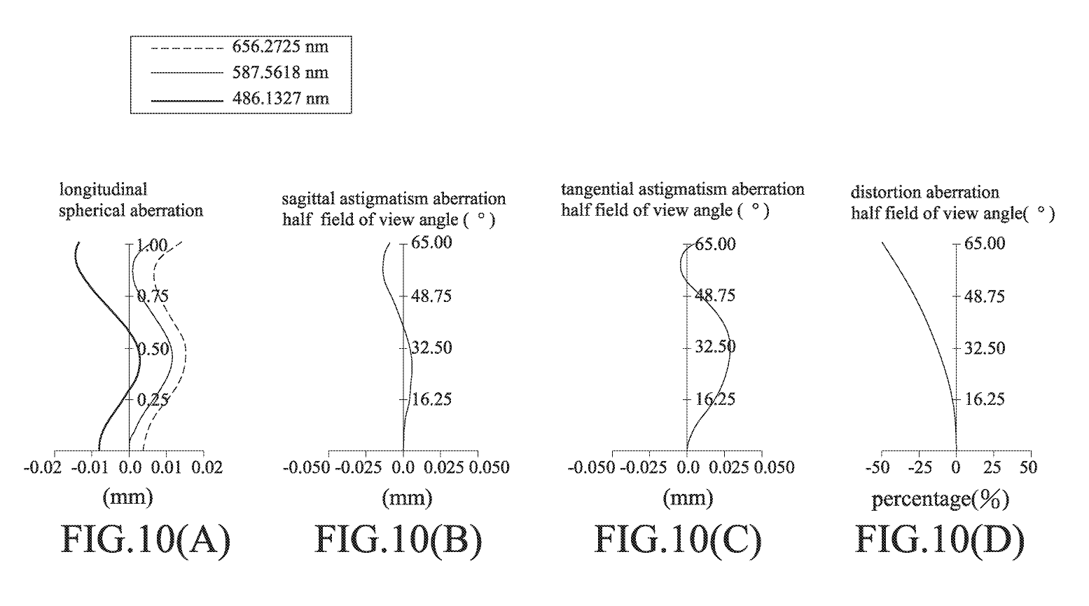

FIGS. 10(A) to 10(D) respectively show simulation results corresponding to longitudinal spherical aberration, sagittal astigmatism aberration, tangential astigmatism aberration, and distortion aberration of the third embodiment. It can be understood from FIGS. 10(A) to 10(D) that the third embodiment is able to achieve a relatively good optical performance.

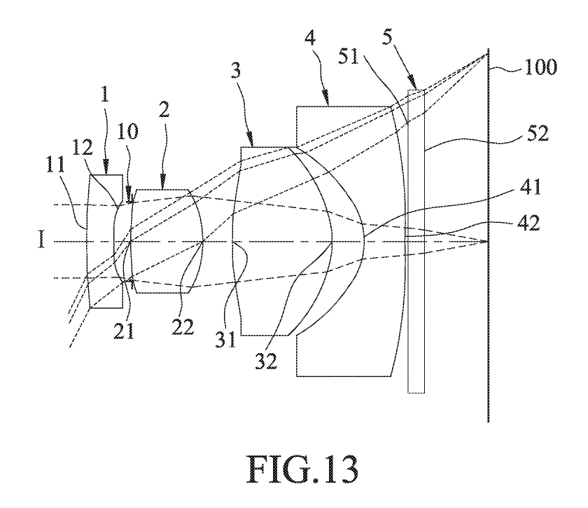

FIG. 13 illustrates a wide-angle imaging lens module according to a fourth embodiment of the present disclosure. The differences of the third embodiment reside in the optical data, the conic constants, the aspherical coefficients and distance parameters of the first, second, third and fourth lenses 1, 2, 3, 4 used in the fourth embodiment.

The focal length of the first lens 1 is −3.2130 mm. The Abbe number of the first lens 1 is 30.5. The focal length of the second lens 2 is 2.0920 mm. The Abbe number of the second lens 2 is 56. The focal length of the third lens 3 is 2.0340 mm. The Abbe number of the third lens 3 is 56. The focal length of the fourth lens 4 is 31 1.4370 mm. The Abbe number of the fourth lens 4 is 23.

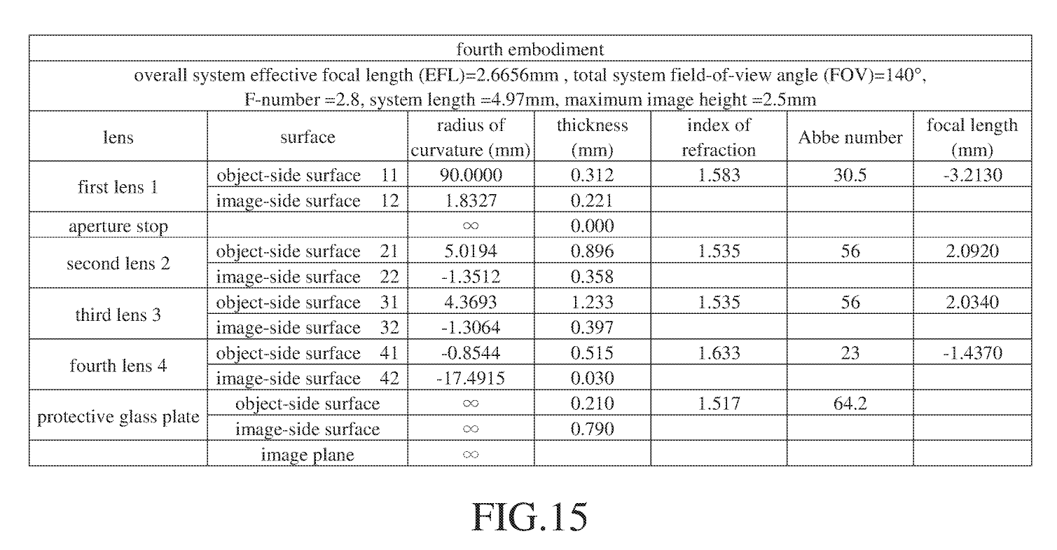

Shown in FIG. 15 is a table that lists some optical data of the first, second, third and fourth lenses 1, 2, 3, 4 used in the wide-angle imaging lens module of the fourth embodiment. The wide-angle imaging lens module has an overall system effective focal length of 2.6656 mm, a total system field-of-view angle of 140°, and a system length of 4.97 mm. The maximum image height of the wide-angle imaging lens module is 2.5 mm. The aperture stop 10 has an F number (Fno) of 2.8.

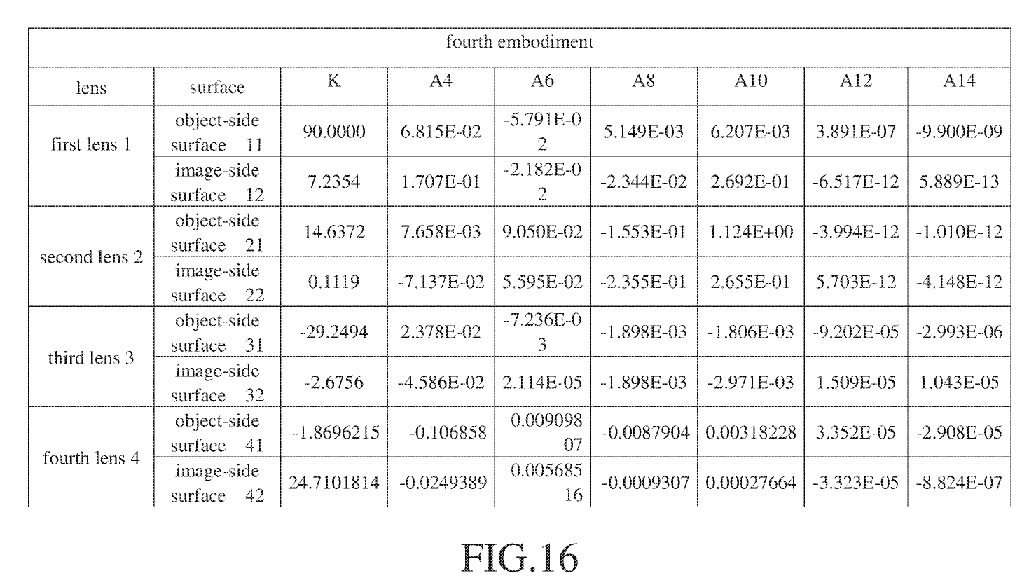

Shown in FIG. 16 is a table that lists values of K and A₂ᵢ of the first, second, third and fourth lenses 1, 2, 3, 4 in the aforementioned relationship (1) for the fourth embodiment.

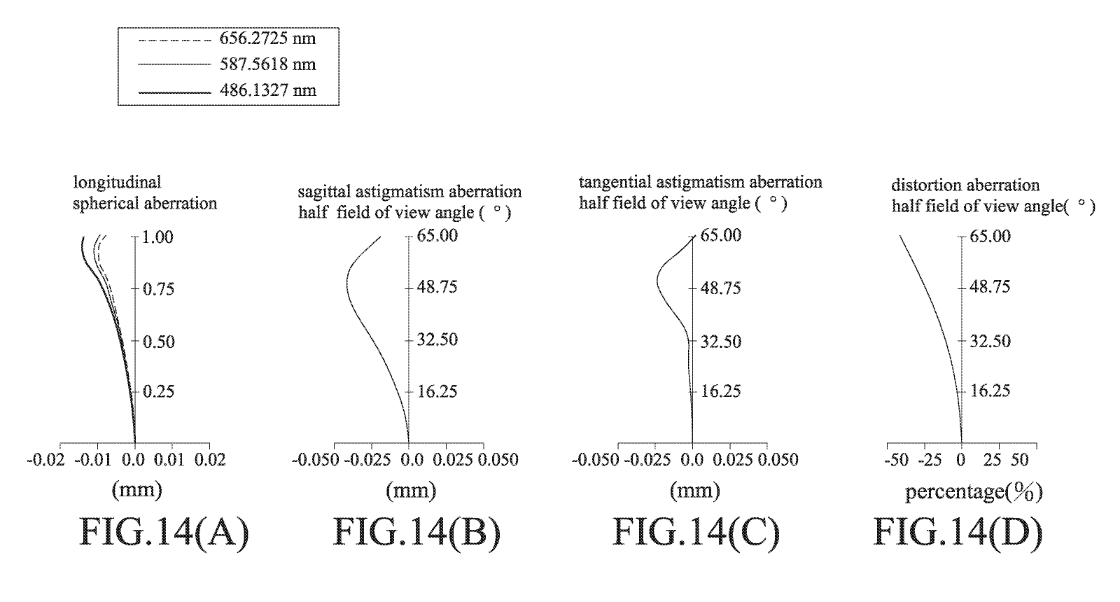

FIGS. 14(A) to 14(D) respectively show simulation results corresponding to longitudinal spherical aberration, sagittal astigmatism aberration, tangential astigmatism aberration, and distortion aberration of the fourth embodiment. It can be understood from FIGS. 14(A) to 14(D) that the fourth embodiment is able to achieve a relatively good optical performance.

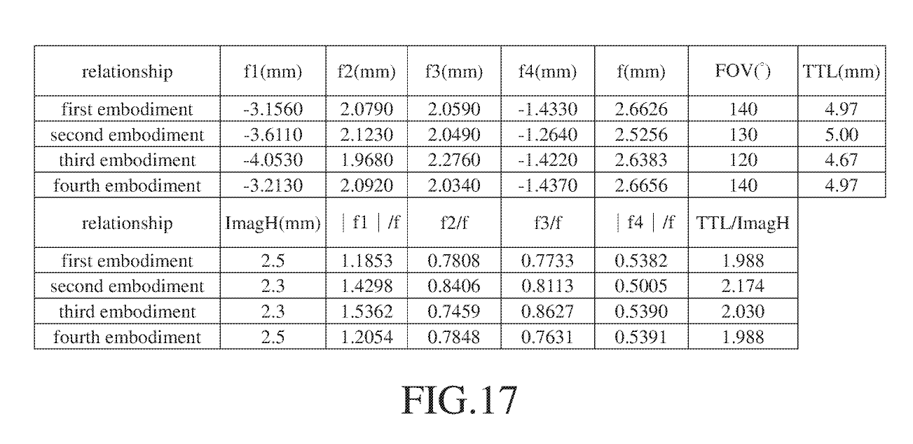

Shown in FIG. 17 is a table that lists optical parameters of all of the first to fourth embodiments. By virtue of the refractive powers and surface structures that are particularly arranged for the first, second, third and fourth lenses 1, 2, 3, 4, the wide-angle imaging lens module of the present disclosure can achieve the purposes to effectively correct optical and chromatic aberrations and to simultaneously have a relatively wide total system field-of-view angle when satisfying:
0.84<|f1|/f<2.28;
0.52<f2/f<1.26;
0.49<f3/f<1.12;
0.32<|f4|/f<0.70;
FOV>100′; and
TTL/ImagH<2.80,
   where f1 denotes a focal length of the first lens 1, f2 denotes a focal length of the second lens 2, f3 denotes a focal length of the third lens 3, f4 denotes a focal length of the fourth lens 4, f denotes the total system focal length of the wide-angle imaging lens module, FOV denotes the total system field-of-view angle of the wide-angle imaging lens module, and ImagH denotes the maximum image height of the wide-angle imaging lens module.

When |f1|/f is smaller than the above lower limit, the optical aberration becomes large and, especially, curvature of field and astigmatism get worsened. When |f1|/f is greater than its upper limit, an angle of refracted light tends to be small so that FOV is unable to be enlarged. When f2/f is smaller than the above lower limit, the optical aberration becomes large and, especially, the curvature of field and astigmatism get worsened. When f2/f is greater than its upper limit, TTL becomes longer. When f3/f is smaller than the above lower limit, the optical aberration becomes large and, especially, curvature of field and astigmatism get worsened. When f3/f is greater than its upper limit, TTL becomes longer. When |f4|/f is smaller than the above lower limit, the optical aberration becomes large and, especially, a transverse chromatic aberration gets worsened. When |f4|/f is greater than its upper limit, the optical aberration becomes large and, especially, the distortion aberration gets worsened.

In addition, each of the first and fourth lenses 1, 4 has negative refractive power and a high dispersion (i.e. a low Abbe number). That is to say, the wide-angel imaging lens module of the present disclosure can effectively correct the system chromatic aberration when satisfying V1<40 and V4<40, where V1 denotes the Abbe number of the first lens 1, and V4 denotes the Abbe number of the fourth lens 4. When either V1 is greater than the aforesaid limit value or V4 is greater than the aforesaid limit value, the system chromatic aberration of the wide-angle imaging lens module cannot be sufficiently corrected.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A wide-angle imaging lens module comprising a first lens having a negative refractive power, an aperture stop, a second lens having a positive refractive power, a third lens having a positive refractive power, and a fourth lens having a negative refractive power, said first lens, said aperture stop, said second lens, said third lens and said fourth lens being arranged in sequence from an object side to an image side along an optical axis of said wide-angle imaging lens module, each of said first, second, third and fourth lenses having an object-side surface facing toward the object side, and an image-side surface facing toward the image side to allow an imaging light to pass therethrough, wherein:
said image-side surface of said first lens is concave away from the image side;
said image-side surface of said second lens is convex toward the image side;
said image-side surface of said third lens is convex toward the image side, at least one of said object-side and image-side surfaces of said third lens being an aspherical surface;
said image-side surface of said fourth lens is convex toward the image side, each of said object-side and image-side surfaces of said fourth lens being an aspherical surface; and
said wide-angle imaging lens module satisfies:
0.84<|f1|/f<2.28;
0.52<f2/f<1.26;
0.49<f3/f<1.12;
0.32<|f4|/f<0.70;
FOV>100′; and
TTL/ImagH<2.80,
where
f1 denotes a focal length of said first lens,
f2 denotes a focal length of said second lens,
f3 denotes a focal length of said third lens,
f4 denotes a focal length of said fourth lens,
f denotes a total system focal length of said wide-angle imaging lens module,
FOV denotes a total system field-of-view angle of said wide-angle imaging lens module,
TTL denotes a system length of said wide-angle imaging lens module, and
ImagH denotes a maximum image height of said wide-angle imaging lens module.

2. The wide-angle imaging lens module as claimed in claim 1, further satisfying V1<40, where V1 denotes an Abbe number of said first lens.

3. The wide-angle imaging lens module as claimed in claim 1, further satisfying V4<40, where V4 denotes an Abbe number of said fourth lens.
